(19) United States
(12) Patent Application Publication
(10) Pub. No.: US 2008/0169899 A1
(43) Pub. Date: Jul. 17, 2008

(54) Voice programmable and voice activated vehicle-based appliance remote control

(75) Inventors: Jason G. Bauman, Huntington Woods, MI (US); Jody K. Harwood, Canton, MI (US); Sumithra Krishnan, Canton, MI (US); Kenan R. Rudnick, Bloomfield Hills, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 11/652,984

(22) Filed: Jan. 12, 2007

(51) Int. Cl. G05B 19/00; G10L 15/00

(52) U.S. Cl. 340/5.23; 704/231; 704/E15.003

(57) ABSTRACT

A programmable controller for activating an appliance controlled by an activation signal is voice-programmable and voice-activated. If a user verbally indicates the appliance is activated by a rolling code activation signal, the controller transmits a sequence of different rolling code activation signals until the user verbally indicates a successful rolling code transmission. The controller stores data representing the successful rolling code transmission. If the user verbally indicates the appliance is activated by a fixed code activation signal, the controller uses a fixed code word to transmit each of a sequence of different fixed code activation signals until the user verbally indicates a successful fixed code transmission. The controller then stores data representing the fixed code word and a fixed code scheme used to generate the successful fixed code transmission. In response to the user verbally identifying an activation input, the controller transmits an activation signal based on stored data.

### BACKGROUND OF THE INVENTION

1. Field of the Invention

The present invention relates to in-vehicle wireless remote control of appliances such as, for example, garage door openers.

2. Background Art

Home appliances, such as garage door openers, security gates, home alarms, lighting, and the like, may conveniently be operated from a remote control. Typically, the remote control is purchased together with the appliance. The remote control transmits a radio frequency (RF) activation signal which is recognized by a receiver associated with the appliance. Aftermarket remote controls are popular as such controllers can offer functionality different from the original equipment's remote control. Such functionality includes decreased size, multiple appliance interoperability, increased performance, and the like. Aftermarket controllers are also purchased to replace lost or damaged controllers or to simply provide another remote control for accessing the appliance.

An example application for aftermarket remote controls are remote garage door openers integrated into an automotive vehicle. These integrated remote controls provide customer convenience, appliance interoperability, increased safety, and enhanced vehicle value. Present in-vehicle integrated remote controls provide a “universal” or programmable garage door opener which learns characteristics of an activation signal received from an existing transmitter then, when prompted by a user, generates a single activation signal having the same characteristics. A problem with such devices is the difficulty experienced by users in programming these devices.

Automotive vehicles increasingly include a wide variety of standard features and options which interact with a user. Examples include in-vehicle entertainment systems, graphical mapping and positioning systems, integrated telephones, artificial speech status and information systems, voice recognition systems, and the like. These systems allow users to input and receive extensive amounts of information and complex concepts.

What is needed is to incorporate advances in human vehicle-interfaces into the programming and activating processes of an in-vehicle integrated remote control.

### SUMMARY OF THE INVENTION

The present invention provides a universal in-vehicle remote control that is voice programmable and voice activated.

An embodiment of the present invention provides a system for wirelessly activating an appliance responsive to one of a plurality of transmission schemes. The system includes a transmitter operative to transmit a radio frequency activation signal based on any of the plurality of transmission schemes. The system includes at least one user activation input, each activation input identifying a wireless channel. The system includes memory holding data describing a plurality of rolling code transmission schemes and a plurality of fixed code transmission schemes. The system includes a voice recognizer for converting human user speech into electrical signals, and a voice generator for converting electrical signals into human user speech. The system includes control logic in communication with the transmitter, the at least one user activation input, the voice recognizer, the voice generator, and the memory. The control logic implements a rolling code programming mode, a fixed code programming mode, and an operating mode.

The control logic in rolling code programming mode generating and transmitting a sequence of rolling code activation signals until the voice recognizer receives human speech from a user indicating a successful rolling code transmission scheme. Each rolling code activation signal in the sequence of rolling code activation signals is based on a different one of the rolling code transmission schemes. The control logic stores data specifying the successful rolling code transmission scheme associated with one of the at least one activation inputs and causing the voice generator to audibly generate human speech indicative of the activation input associated with the successful rolling code transmission scheme for the user to hear.

The control logic in fixed code programming mode receiving a fixed code from the voice recognizer upon the voice recognizer receiving human speech from a user identifying the fixed code. The control logic then generates and transmits a sequence of fixed code activation signals until the voice recognizer receives human speech from a user indicating a successful fixed code transmission scheme. Each fixed code activation signal in the sequence of fixed code activation signals based on one of the plurality of fixed code transmission schemes and each transmitting the received fixed code. The control logic storing the fixed code and data specifying the successful fixed code transmission scheme associated with one of the at least one activation inputs and causing the voice generator to generate human speech indicative of the activation input associated with the successful fixed code transmission scheme for the user to hear.

The control logic in operating mode receiving identification of an activation input to be activated from the voice recognizer upon the voice recognizer receiving human speech from a user identifying the activation input to be activated, retrieving data associated with the identified activation input, and transmitting an activation signal based on the retrieved data.

Another embodiment of the present invention provides a method of activating an appliance, the appliance controlled by a RF activation signal. The method includes if a user verbally indicates that the appliance is activated by a rolling code activation signal, then transmitting a sequence of different rolling code activation signals until the user verbally indicates a successful rolling code transmission and then storing data representing a rolling code scheme used to generate the successful rolling code transmission. The method includes if the user verbally indicates that the appliance is activated by a fixed code activation signal, then using a fixed code word to generate and transmit each of a sequence of different fixed code activation signals until the user verbally indicates a successful fixed code transmission and then storing data representing the fixed code word and a fixed code scheme used to generate the successful fixed code transmission. In response to the user verbally identifying an activation input, the method includes generating and transmitting an activation signal based on stored data.

Another embodiment of the present invention provides a method of programming a programmable remote control to one of a plurality of appliance activation schemes. The method includes receiving user type voice input specifying activation signal type. The method includes if the user type voice input specifies variable code type, then transmitting variable code activation signals until receiving user success voice input indicating a target appliance has been activated. The method includes if the user type voice input specifies fixed code type, then receiving user fixed code voice input providing a fixed code and transmitting fixed code activation signals until receiving user success voice input indicating the target appliance has been activated. The method includes storing information specifying an activation signal for activating the target appliance based on the received user success voice input.

The above features, and other features and advantages of the present invention are readily apparent from the following detailed descriptions thereof when taken in connection with the accompanying drawings.

### BRIEF DESCRIPTION OF THE DRAWINGS

FIG. 1 illustrates a block diagram of an appliance control system according to an embodiment of the present invention;

FIG. 2 illustrates activation signal characteristics according to an embodiment of the present invention;

FIG. 3 illustrates a block diagram of rolling code operation that may be used with the present invention;

FIG. 4 illustrates a fixed code setting which may be used according to an embodiment of the present invention;

FIG. 5 illustrates a block diagram of a programmable remote control according to an embodiment of the present invention;

FIG. 6 illustrates a block diagram of control logic and a user interface according to an embodiment of the present invention;

FIG. 7 is a memory map for implementing control modes according to an embodiment of the present invention;

FIGS. 8, 9, 10, and 11 are flow diagrams illustrating programmable controller operations in accordance with an embodiment of the present invention;

FIGS. 12, 13, and 14 are flow diagrams illustrating voice programming and voice activation programmable controller operations in accordance with an embodiment of the present invention;

FIG. 15 illustrates a vehicle interior that may be used to program a programmable controller according to an embodiment of the present invention;

FIG. 16 is a block diagram illustrating a bus-based automotive vehicle electronics system according to an embodiment of the present invention; and

FIG. 17 is a block diagram illustrating distributed control elements interconnected by a vehicle bus according to an embodiment of the present invention.

### DETAILED DESCRIPTION OF THE PREFERRED EMBODIMENT(S)

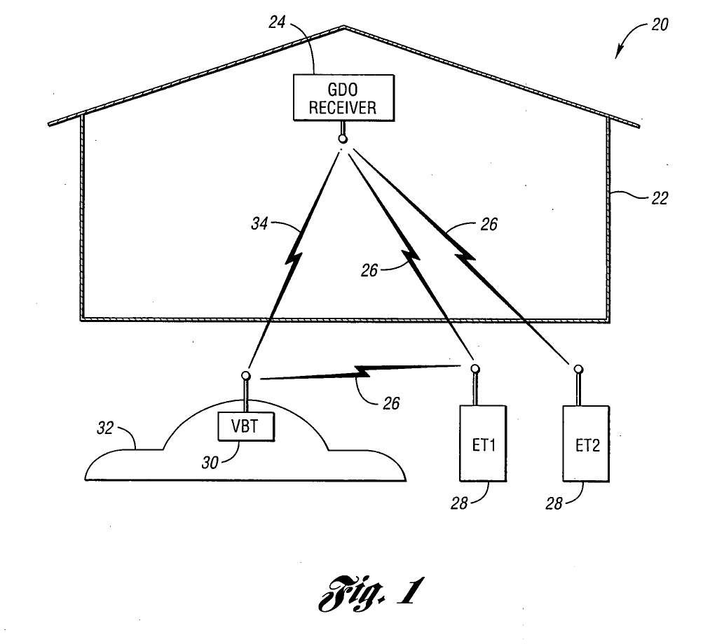

Referring to FIG. 1, a block diagram illustrating an appliance control system 20 according to an embodiment of the present invention is shown. Appliance control system 20 allows one or more appliances to be remotely controlled using radio transmitters. In the example shown, radio frequency (RF) remote controls are used to operate a garage door opener (GDO). However, the present invention may be applied to controlling a wide variety of appliances such as other mechanical barriers, lighting, alarm systems, temperature control systems, and the like.

Appliance control system 20 includes garage 22 having a garage door. GDO receiver 24 receives RF control signals 26 for controlling the GDO. Activation signals have a transmission scheme which may be represented as a set of receiver characteristics. One or more existing transmitters (ET) 28 generate RF activation signals 26 exhibiting the receiver characteristics in response to user activation.

A user of appliance control system 20 may wish to add a new transmitter to system 20. For example, a vehicle-based transmitter (VBT) including programable control 30 may be installed in vehicle 32. VBT 30 generates a sequence of activation signals 34 which includes an activation signal having characteristics appropriate to activate activating GDO receiver 24. In the embodiment shown, programmable control 30 is mounted in vehicle 32. However, the present invention applies to universal remote controls that may also be hand-held, wall mounted, included in a key fob, and the like.

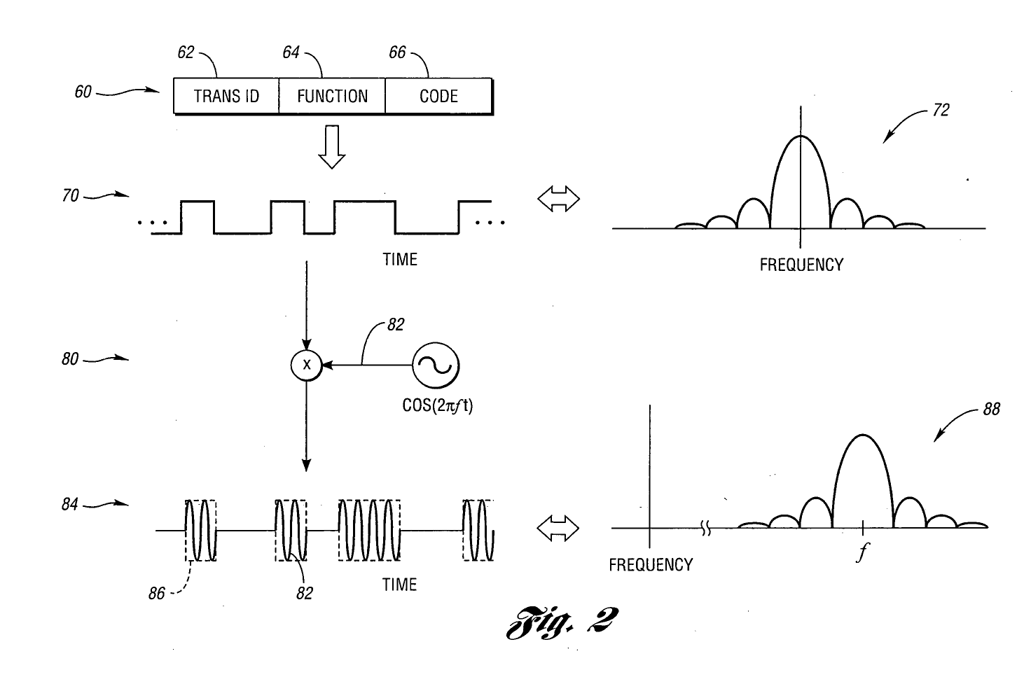

Referring now to FIG. 2, a schematic diagram illustrating activation signal characteristics according to an embodiment of the present invention is shown. Information transmitted in an activation signal is typically represented as a binary data word 60. Data word 60 may include one or more fields, such as transmitter identifier 62, function indicator 64, code word 66, and the like. Transmitter identifier (TRANS ID) 62 uniquely identifies a remote control transmitter. Function indicator 64 indicates which of a plurality of functional buttons on the remote control transmitter were activated. Code word 66 helps to prevent mis-activation and unauthorized access.

Several types of codes 66 are possible. One type of code is a fixed code, wherein each transmission from a given remote control transmitter contains the same code 66. In contrast, variable code schemes change the bit pattern of code with each activation. The most common variable code scheme, known as rolling code, generates code 66 by encrypting a synchronization (sync) counter value. After each activation, the counter is incremented. The encryption technique is such that a sequence of encrypted counter values appears to be random numbers.

Data word 60 is converted to a baseband stream 70 which is an analog signal typically transitioning between a high voltage level and a low voltage level. Multilevel transmissions are also possible. Various baseband encoding or modulation schemes are known, including polar signaling, on-off signaling, bipolar signaling, duobinary signaling, Manchester signaling, and the like. Baseband stream 70 has a baseband power spectral density 72 centered around a frequency of zero.

Baseband stream 70 is converted to a RF signal through a modulation process shown generally by 80. Baseband stream 70 is used to modulate one or more characteristics of carrier 82 to produce a broadband signal 84. Modulation process 80, mathematically illustrated by multiplication in FIG. 2, implements a form of amplitude modulation commonly referred to as on-off keying. As will be recognized by one of ordinary skill in the art, many other modulation forms are possible, including frequency modulation, phase modulation, and the like. In the example shown, baseband stream 70 forms envelope 86 modulating carrier 82. As illustrated in broadband power spectral density 88, the effect in the frequency domain is to shift baseband power spectral density 72 up in frequency so as to be centered around the carrier frequency, f, of carrier 82.

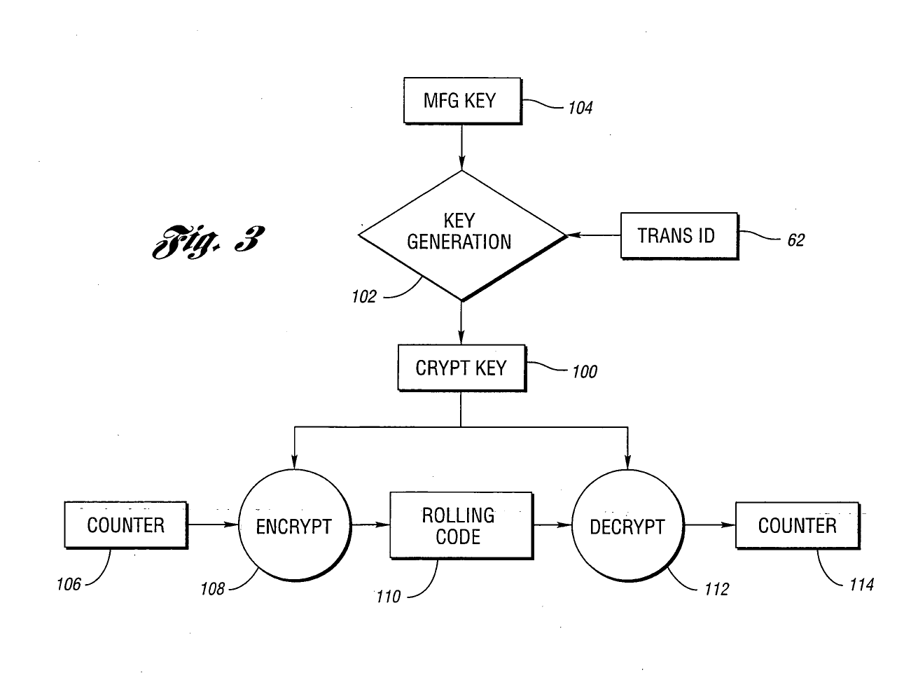

Referring now to FIG. 3, a block diagram illustrating rolling code operation that may be used with the present invention is shown. Remotely controlled systems using rolling code require crypt key 100 in both the transmitter and the receiver for normal operation. In a well-designed rolling code scheme, crypt key 100 is not transmitted from the transmitter to the receiver. Typically, crypt key 100 is generated using key generation algorithm 102 based on transmitter identifier 62 and a manufacturing (MFG) key 104. Crypt key 100 and transmitter identifier 62 are then stored in a particular transmitter. Counter 106 is also initialized in the transmitter. Each time an activation signal is sent, the transmitter uses encrypt algorithm 108 to generate rolling code value 110 from counter 106 using crypt key 100. The transmitted activation signal includes rolling code 110 and transmitter identifier 62.

A rolling code receiver is trained to a compatible transmitter prior to normal operation. The receiver is placed into a learn mode. Upon reception of an activation signal, the receiver extracts transmitter identifier 62. The receiver then uses key generation algorithm 102 with manufacturing key 104 and received transmitter identifier 62 to generate crypt key 100 identical to the crypt key used by the transmitter. Newly generated crypt key 100 is used by decrypt algorithm 112 to decrypt rolling code 110, producing counter 114 equal to counter 106. The receiver then saves counter 114 and crypt key 100 associated with transmitter identifier 62. Encrypt algorithm 108 and decrypt algorithm 112 may be the same algorithm.

In normal operation, when the receiver receives an activation signal, the receiver first extracts transmitter identifier 62 and compares transmitter identifier with all learned transmitter identifiers. If no match is found, the receiver rejects the activation signal. If a match is found, the receiver retrieves crypt key 100 associated with received transmitter identifier 62 and decrypts rolling code 110 from the received activation signal to produce counter 114. If received counter 106 matches counter 114 associated with transmitter identifier 62, activation proceeds. Received counter 106 may also exceed stored counter 114 by a preset amount for successful activation.

Another rolling code scheme generates crypt key 100 based on manufacturing key 104 and a “seed” or random number. An existing transmitter sends this seed to an appliance receiver when the receiver is placed in learn mode. The transmitter typically has a special mode for transmitting the seed that is entered, for example, by pushing a particular combination of buttons. The receiver uses the seed to generate crypt key 100. The present invention applies to the use of a seed for generating a crypt key as well as to any other variable code scheme.

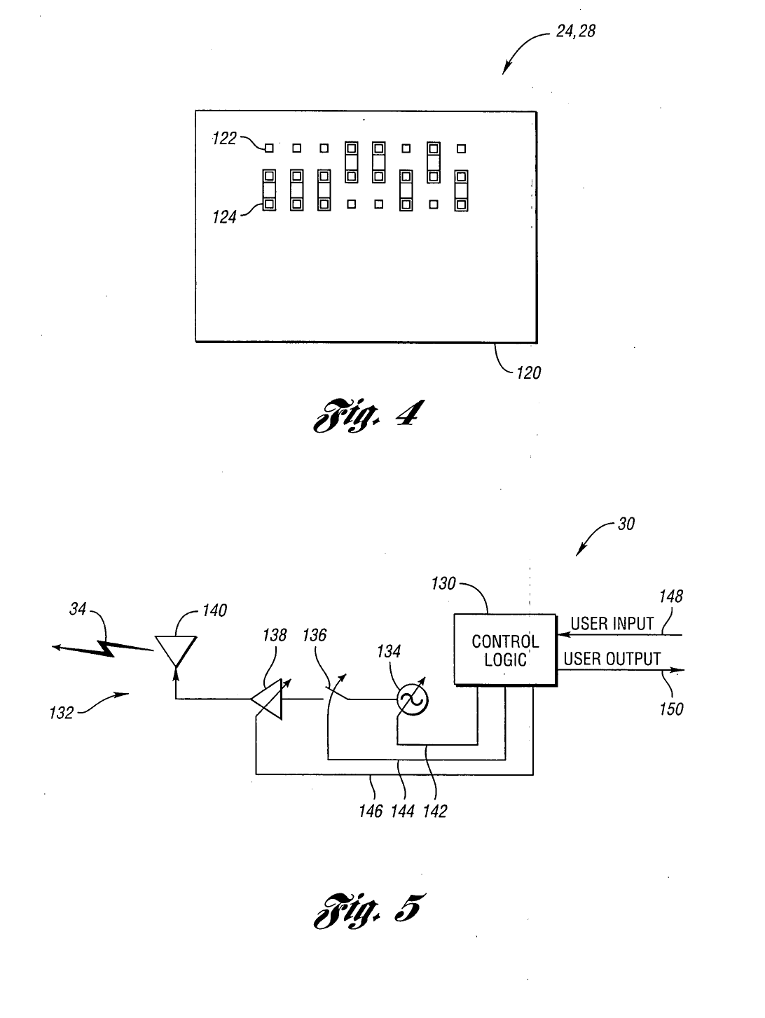

Referring now to FIG. 4, a schematic diagram illustrating a fixed code setting which may used according to an embodiment of the present invention is shown. Fixed code systems typically permit a user to set the fixed code value through a set of DIP switches or jumpers. For example, fixed code receiver 24 and transmitter 28 may each include printed circuit board 120 having a plurality of pins, one of which is indicated by 122, together with support electronics. Pins 122 are arranged in a grid having three rows and a number of columns equal to the number of bits in the fixed code value. A jumper, one of which is indicated by 124, is placed in each column straddling either the first and second pins or the second and third pins. One position represents a logical “1” and the other position represents a logical “0.” Various alternative schemes are also possible. For example, two rows may be used, with the presence or absence of jumper 124 indicating one of the logical binary values. As another alternative, a set of DIP switches may be used with “up” representing one binary value and “down” representing the other.

In various embodiments of the present invention, a user is asked to read the fixed code value from existing transmitter 28 or appliance receiver 24 and verbally speak this fixed code value for receipt by programmable control 30. A difficulty experienced by users asked to read such values is in determining from which end to start. Another difficulty is in determining which setting represents a binary “1” and which setting represents a binary “0.” For example, the pattern represented in FIG. 4 may be interpreted as “00011010,” “11100101,” “01011000” or “10100111.” Entering an incorrect value can frustrate a user who is not sure why he cannot program his fixed code transmitter. To rectify this situation, embodiments of the present invention transmits fixed code activation signals based on the fixed code value as entered by the user and at least one of a bitwise reversal of the fixed code, a bitwise inversion of the fixed code, and both a bitwise reversal and inversion.

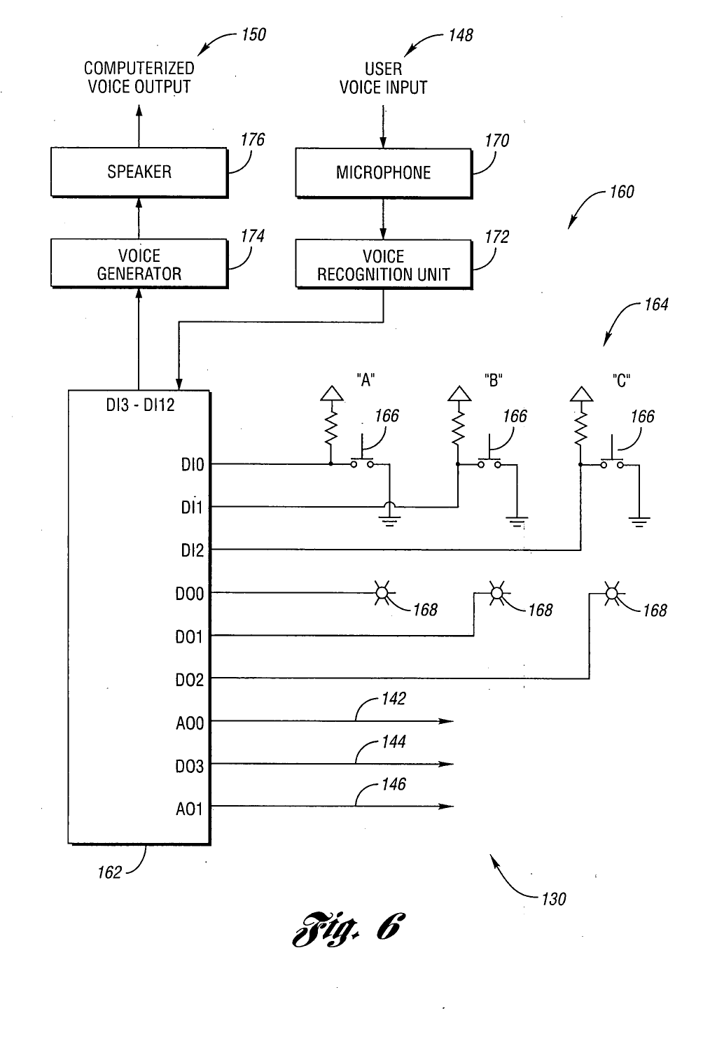

Referring now to FIG. 5, a block diagram illustrating a programmable remote control 30 according to an embodiment of the present invention is shown. Programmable control 30 includes control logic 130 and a transmitter section, shown generally by 132. Transmitter section 132 includes variable frequency oscillator 134, modulator 136, variable gain amplifier 138, and antenna 140. For each activation signal in sequence of activation signals 34, control logic 130 sets the carrier frequency of the activation signal generated by variable frequency oscillator 134 using frequency control signal 142. Control logic 132 modulates the carrier frequency with modulator 136 to produce an activation signal which is amplified by variable gain amplifier 138. Modulator 136 may be controlled by shifting a data word serially onto modulation control signal 144. Other forms of modulation are possible, such as frequency modulation, phase modulation, and the like. Variable gain amplifier 138 is set to provide the maximum allowable output power to antenna 140 using gain control signal 146.

Control logic 130 receives user input 148 including remote control programming and activation commands spoken by a human user. User voice input 148 may be provided from the user to control logic 130 through a microphone and voice recognition unit (VRU) directly connected to control logic 130, indirectly connected to control logic 130 via a serial bus, incorporated with control logic 130, etc. Control logic 130 generates user output 150 including remote control programming and activation information for the user to hear as computer-synthesized voice. User voice output 150 may be provided from control logic 130 to the user through a speaker and voice synthesizer directly connected to control logic 130, indirectly connected to control logic 130, incorporated with control logic 130, etc.

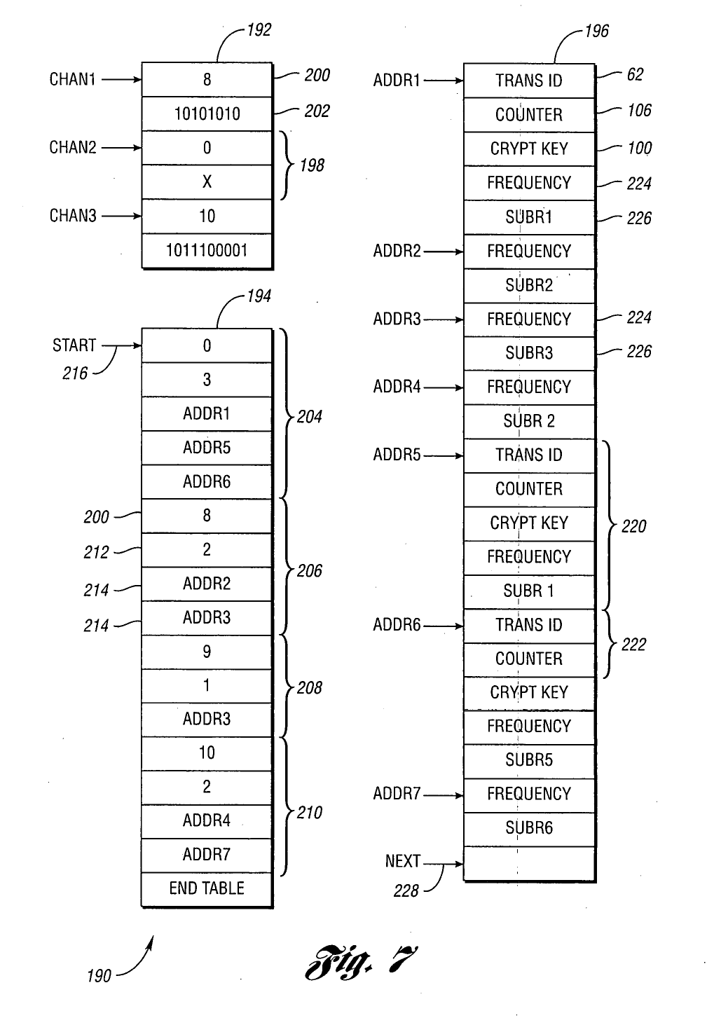

Referring now to FIG. 6, a schematic diagram illustrating control logic 130 and a user interface 160 according to an embodiment of the present invention is shown. Control logic 130 and electronics for a user interface 160 can be implemented with microcontroller 162. User interface 160 includes at least one activation input 164. Three activation inputs 164 are shown, labeled “A,” “B” and “C.” Each activation input 164 is implemented with a pushbutton switch 166 which provide a voltage signal to a digital input (DI) for microcontroller 162. User interface 160 includes an indicator lamp 168 associated with each activation input Each indicator lamp 168 may be implemented using one or more light emitting diodes supplied by a digital output (DO) from microcontroller 162.

User interface 160 enables a human user of programmable control 30 to provide user input 148 to microcontroller 162. As indicated above and as will be described below, user input 148 may include information, commands, requests, etc., spoken by the user. In accordance with the present invention, user voice input 148 includes programming and/or activation information spoken by the user. To this end, user interface 160 includes a microphone 170 and a VRU 172 connected to microcontroller 162. In operation, a user speaks information such as a programming or activation command into microphone 170. Microphone 170 converts the spoken command into an electronic signal. VRU 172 analyzes the electronic signal to provide a signal indicative of the command to microcontroller

User interface 160 enables programmable control 30 to provide user output 150 to the user. As indicated above and as will be described below, user output 150 may include information, commands, requests, etc., spoken as a computerized voice by microcontroller 162 for the user to hear. As indicated above and as will be described below, computerized voice output 150 may include programming and/or activation information generated by microcontroller 162 for the user to hear. To this end, user interface 160 includes a voice generator 174 and a speaker 176 connected to microcontroller 162. In operation, microcontroller 162 outputs an electronic signal indicative of information such as a programming request to voice generator 174. Voice generator 174 converts the electronic signal into a computerized voice signal. Speaker 176 outputs the computerized voice signal for the user to hear the programming request.

Microcontroller 162 generates control signals determining characteristics of transmitted activation signals. Frequency control signal 142 is delivered from an analog output (AO) on microcontroller 162. For example, if variable frequency oscillator 134 is implemented using a voltage controlled oscillator, varying the voltage on frequency control signal 142 controls the carrier frequency of the activation signal. Frequency control signal 142 may also be one or more digital outputs used to select between fixed frequency sources. Modulation control signal 144 is provided by a digital output on microcontroller 162. The fixed or rolling code data word is put out on modulation control 144 in conformance with the baseband modulation and bit rate characteristics of the activation scheme being implemented. Microcontroller 162 generates gain control signal 146 as an analog output for controlling the amplitude of the activation signal generated. Analog output signals may be replaced by digital output signals feeding an external digital-to-analog converter.

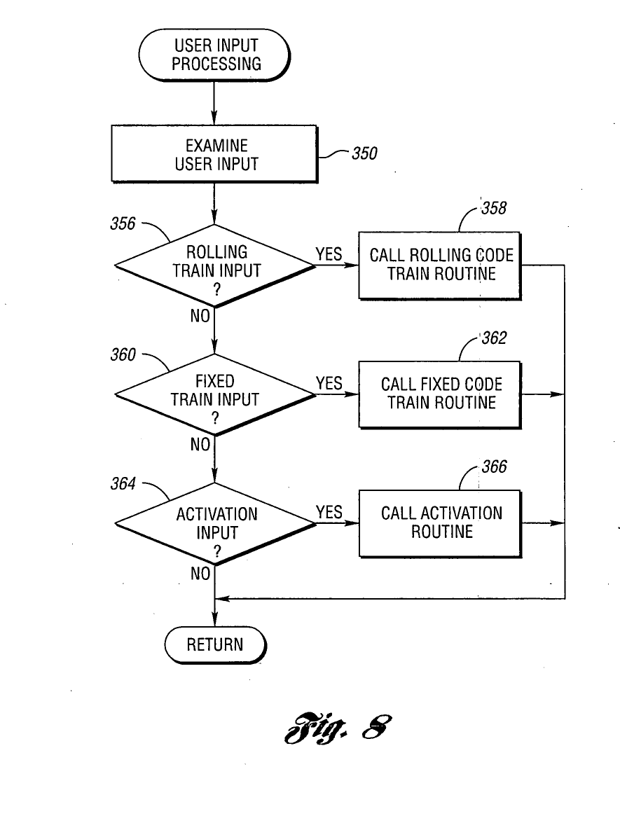

Referring now to FIG. 7, a memory map 190 for implementing operating modes according to an embodiment of the present invention is shown. Memory map 190 represents the allocation of memory for data tables used by programmable control 30. This data may be held in non-volatile memory such as flash memory. Memory map 190 includes channel table 192, mode table 194, and scheme table 196.

Channel table 192 includes a channel entry, one of which is indicated by 198, for each channel supported by programmable control 30. Typically, each channel corresponds to a user activation input. In the example illustrated in FIG. 7, three channels are supported. Each channel entry 198 has two fields, mode indicator 200 and fixed code 202. Mode indicator 200 indicates the mode programmed for that channel. In the embodiment shown, a zero in mode indicator 200 indicates rolling code mode. A non-zero integer in mode indicator 200 indicates a fixed code mode with a code size equal to the integer value. For example, the first channel (CHAN1) has been programmed for eight-bit fixed code operation, the second channel (CHAN2) has been programmed for rolling code operation, and the third channel (CHAN3) has been programmed for ten-bit fixed code operation. Fixed code value 202 holds the programmed fixed code for a fixed code mode. Fixed code value 202 may also hold function code 64 in fixed code modes. Fixed code value 202 may hold function code 64 or may not be used at all in a channel programmed for a rolling code mode.

Mode table 194 contains an entry for each mode supported. The four entries illustrated are rolling code entry 204, eight-bit fixed code entry 206, nine-bit fixed code entry 208, and ten-bit fixed code entry 210. Each entry begins with mode indicator 200 for the mode represented, the next value is scheme count 212 indicating the number of schemes to be sequentially transmitted in that mode. Following scheme count 212 is a scheme address 214 for each scheme. The address of the first entry of mode table 194 is held in table start pointer 216 known by control logic 130. When accessing data for a particular mode, control logic 130 searches through mode table 194 for mode indicator 200 matching the desired mode. The use of mode indicators 200 and scheme counts 212 provides a flexible representation for adding new schemes to each mode and adding new modes to mode table 194.

Scheme table 196 holds characteristics and other information necessary for generating each activation signal in sequence of activation signals 34. Scheme table 196 includes a plurality of rolling code entries, one of which is indicated by 220, and a plurality of fixed code entries, one of which is indicated by Each rolling code entry 220 includes transmitter identifier 62, counter 106, crypt key 100, carrier frequency 224, and subroutine address 226. Subroutine address 226 points to code executable by control logic 130 for generating an activation signal. Additional characteristics may be embedded within this code. Each fixed code entry 222 includes carrier frequency 224 and subroutine address Next pointer 228 points to the next open location after scheme table 196. Any new schemes received by control logic 130 may be appended to scheme table 196 using next pointer 228.

Memory map 190 implements a single rolling code mode and three fixed code modes based on the fixed code size. Other mode arrangement are possible. For example, more than one rolling code modes may be used. Only one fixed code mode may be used. If more than one fixed code mode is used, characteristics other than fixed code size may be used to distinguish between fixed code modes. For example, fixed code schemes may be grouped by carrier frequency, modulation technique, baseband modulation, and the like.

In alternative embodiments, channel table 192 can hold different values for channel entries 198. For example, each channel entry 198 could include scheme address 214 of a successfully trained scheme as well as fixed code value

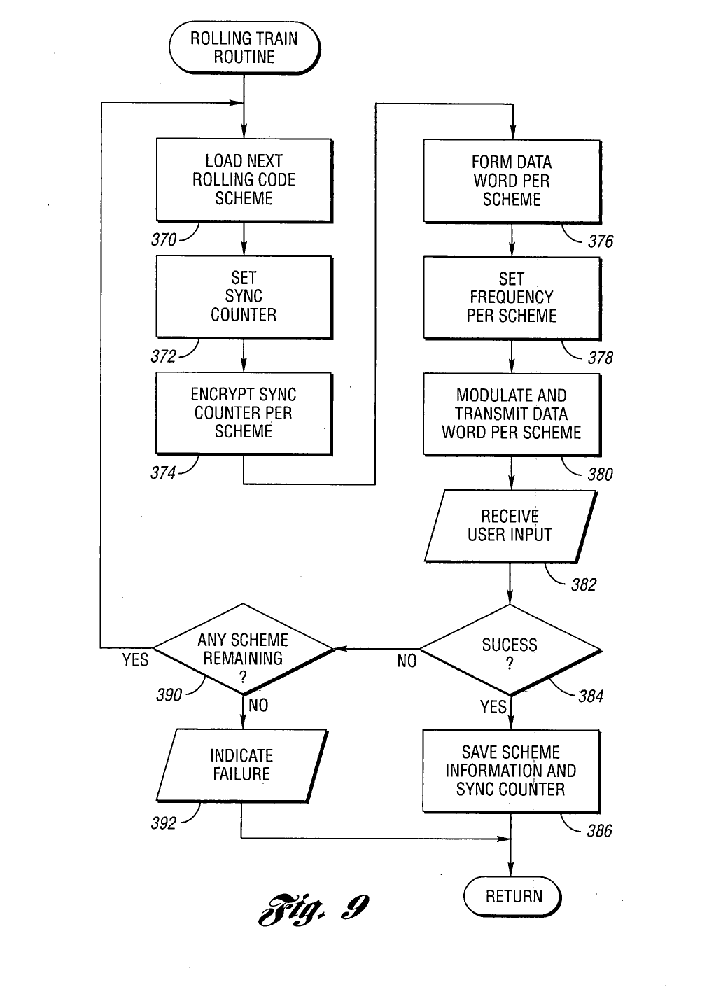

Referring now to FIGS. 8, 9, 10, and 11, flowcharts illustrating programmable controller operations according to an embodiment of the present invention are shown. In FIG. 8, user input processing including rolling code training, fixed code training, and activation is provided. User voice input 148 is examined, as in block 350. A determination is made as to whether or not user voice input 148 specified rolling code training, as in block 356. If so, a rolling code training routine is called, as in block 358. If not, a determination is made as to whether user voice input 148 specified fixed code training, as in block 360. If so, a fixed code training routine is called, as in block 362. If not, a determination is made as to whether user voice input 148 specified activation, as in block 364. If so, an activation routine is called, as in block 366.

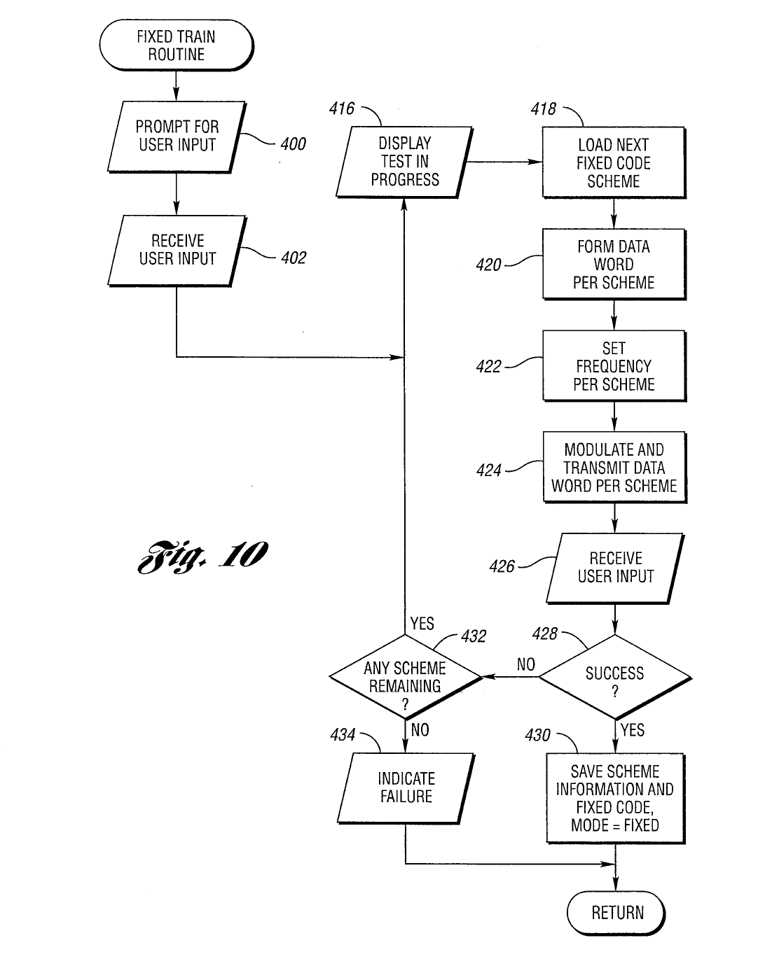

Referring now to FIG. 9, a rolling code training routine is provided. The routine includes a loop in which one or more rolling code activation signals are sent as a test. The user provides as feedback a user voice input 148 indicative of whether or not the target appliance was activated.

The next rolling code scheme in the sequence is loaded, as in block The sync counter, upon which the rolling code is based, is initialized, as in block 372. The sync counter is encrypted according to the current scheme to generate a rolling code value, as in block 374. A data word is formed including the generated rolling code value, as in block 376. The carrier is set, as in block 378. The data word is used to modulate the carrier according to the current scheme, as in block 380. The resulting activation signal is then transmitted.

The guess-and-test approach requires interaction with the user, as in block 382. In one embodiment, the test pauses for a preset amount of time. If no user voice input 148 indicative of the current test being successful is received within this time, the system assumes the current test has failed. A check for success is made, as in block 384. If user voice input 148 indicates activation of the target appliance, then information indicating the one or more successful schemes is saved, as in block 386. This information may be associated with a particular user activation input 164. The user may assign a particular user activation input 164 as part of block 382 or may be audibly prompted to designate an activation input as part of block 386.

Returning to block 384, if the user did not indicate successful activation, a check is made to determine if any schemes remain, as in block 390. If not, an audio failure indication or the like is provided to the user, as in block 392. If any schemes remain, the test loop is repeated.

The training routine illustrated in FIG. 9 indicates a single activation signal is generated for each test. However, multiple activation signals may be generated and sent with each test. In one embodiment, further tests are conducted to narrow down which scheme or schemes successfully activated the appliance. In another embodiment, the programmable control stores information indicating the successful sequence so that the successful sequence is retransmitted each time the appropriate activation input is received.

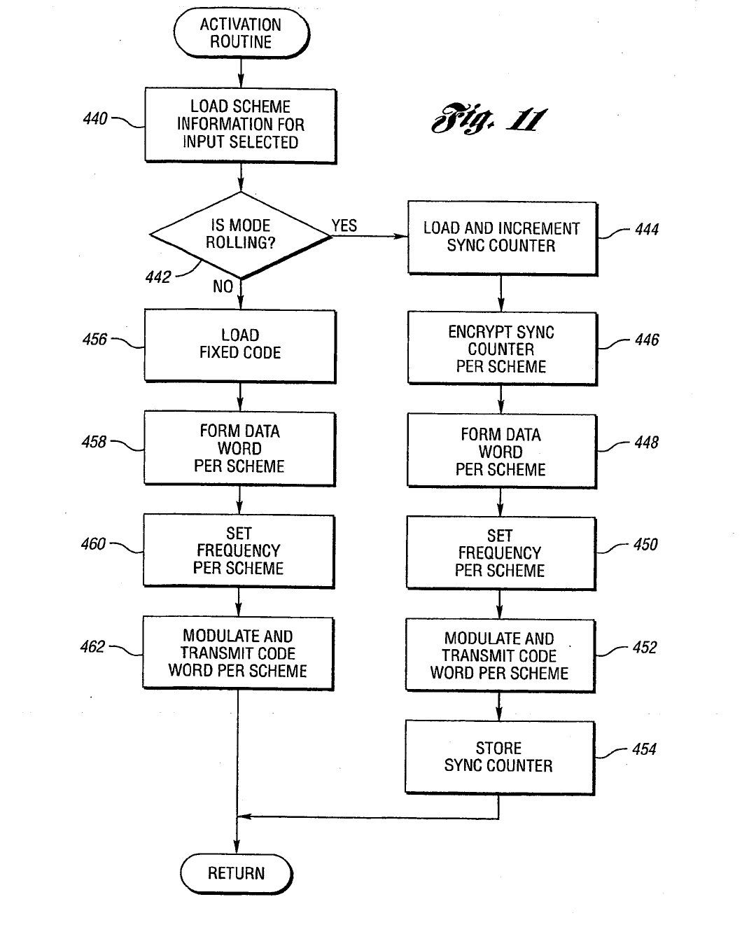

Referring now to FIG. 10, a fixed code training routine is provided. The user is prompted for user voice input 148 indicative of a fixed code value, as in block 400. User voice input 148 is received, as in block 402. Once the fixed code value is received in block 402, a guess-and-test loop is entered. A display may be provided to the user indicating that the test is in progress, as in block 416. Information describing the next fixed code scheme is loaded, as in block 418. A data word is formed containing the fixed code, as in block 420. The carrier frequency is set, as in block 422. The data word is used to modulate the carrier, producing an activation signal, which is then transmitted, as in block 424. User voice input 148 regarding the success of the test is received, as in block 426. Once again, the system may pause for a preset amount of time and, if no input is received, assume that the test was not successful. Alternatively, the system may wait for user voice input specifically indicating success or failure. A check is made to determine whether or not the test was successful, as in block 428. If so, information specifying the one or more successful schemes and the fixed code value are saved. This information may be associated with a particular activation input 164 specified by the user. In addition, the mode is changed to fixed mode for the selected activation input 164. If success was not indicated, a check is made to determine if any schemes remain, as in block 432. If not, failure is verbally outputted to the user, as in block 434. If any schemes remain, the test loop is repeated.

The guess-and-test scheme illustrated in FIG. 10 generates and transmits a single activation signal with each pass through the loop. However, as with rolling code training, more than one fixed code activation signal may be sent within each test. Once success is indicated is audibly indicated by the user, the user may be audibly prompted to further narrow the selection of successful activation signals. Alternatively, information describing the sequence can be stored and the entire sequence retransmitted upon receiving an activation signal to which the sequence is associated.

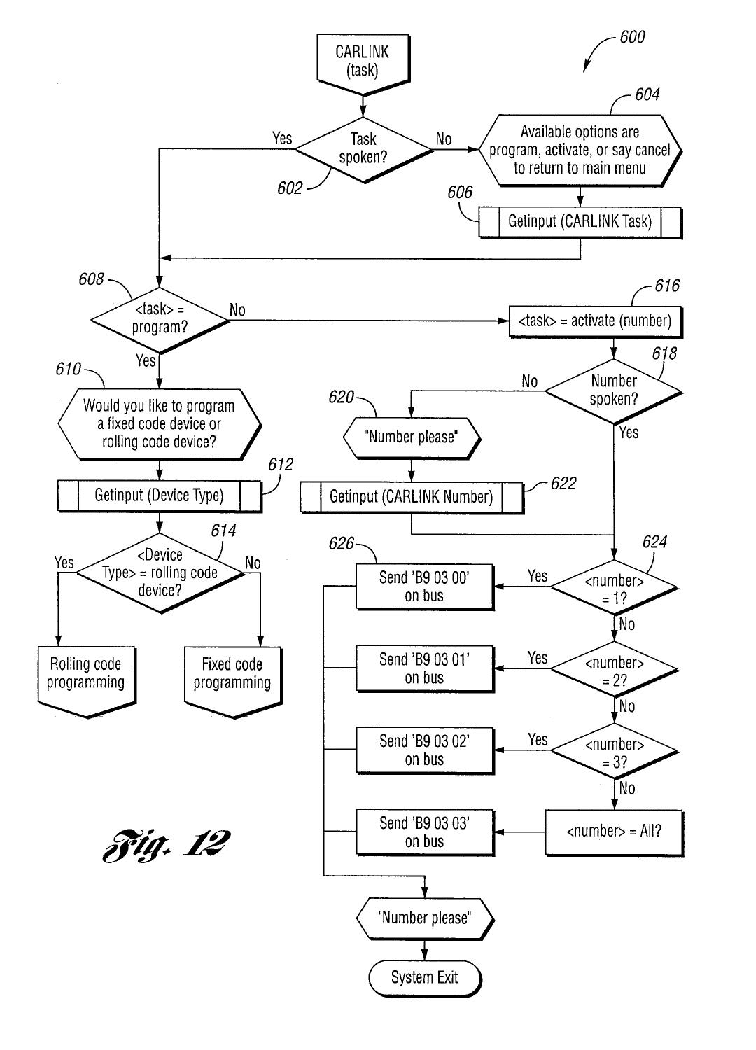

Referring now to FIG. 11, a flow chart illustrating an activation routine according to an embodiment of the present invention is shown. Information associated with an activation input 164 audibly asserted by the user as user voice input 148 is retrieved, as in block 440. A check is made to determine if the mode associated with the activation channel is rolling, as in block 442. If so, the sync counter is loaded and incremented, as in block 444. The sync counter is encrypted to produce a rolling code value, as in block 446. A data word is formed including the rolling code value, as in block 448. The carrier frequency is set, as in block The data word is used to modulate the carrier frequency, producing an activation signal which is then transmitted, as in block 452. The sync counter is stored, as in block 454.

Returning to block 442, if the mode is not rolling, the stored fixed code value is retrieved, as in block 456. A data word is formed including the retrieved fixed code, as in block 458. The carrier frequency is set, as in block 460. The data word is used to modulate the carrier, producing an activation signal which is then transmitted, as in block 462.

Various embodiments for programming to fixed and rolling code appliances and for responding to activation inputs for fixed and rolling code appliances may be provided. For example, programmable control 30 may implement a system which transmits every rolling code activation signal upon activation of a rolling code channel and uses guess-and-test training for programming a fixed code channel. As another example, programmable control 30 may be configured for guess-and-test training using every possible rolling code scheme but, when training for fixed code, generates and transmits activation signals based on only those fixed code schemes known to be used with a fixed code value having a number of bits equal to the number of bits of the fixed code value entered by the user.

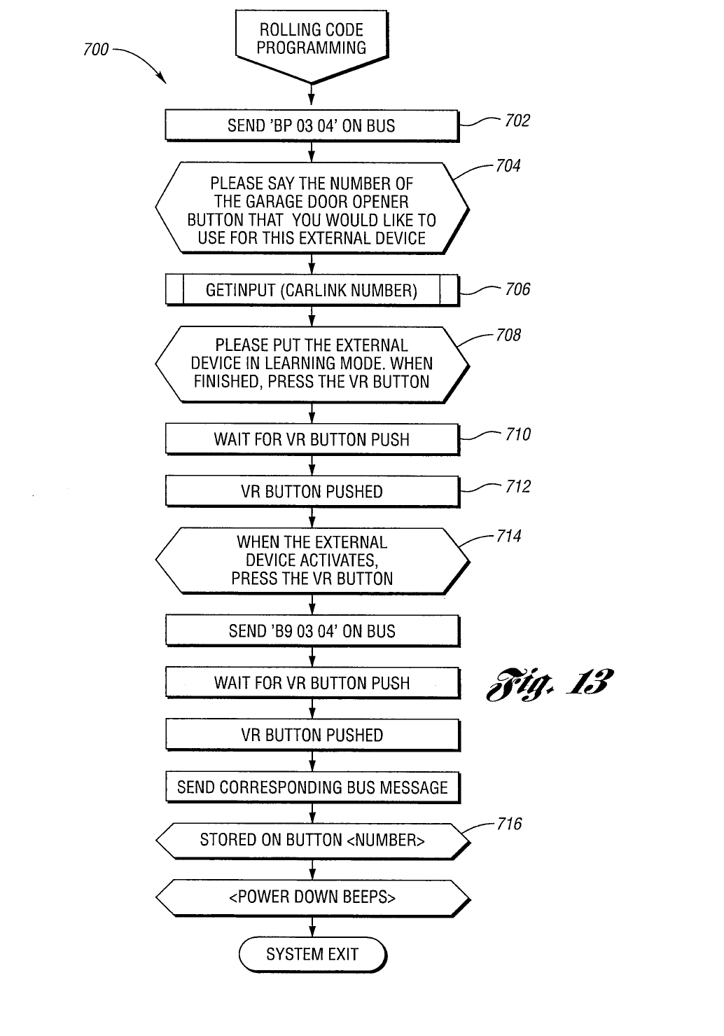

Referring now to FIGS. 12, 13, and 14, flowcharts illustrating programmable control operation according to an embodiment of the present invention are shown. The flowcharts of FIGS. 12, 13, and 14 describe voice programming and voice activation examples of programmable controller 30. In general, a user speaks programming and/or activation information for receipt by programmable controller 30 and the programmable controller generates computerized programming and/or activation information for the user to hear during the programming and/or appliance activation of programmable controller 30.

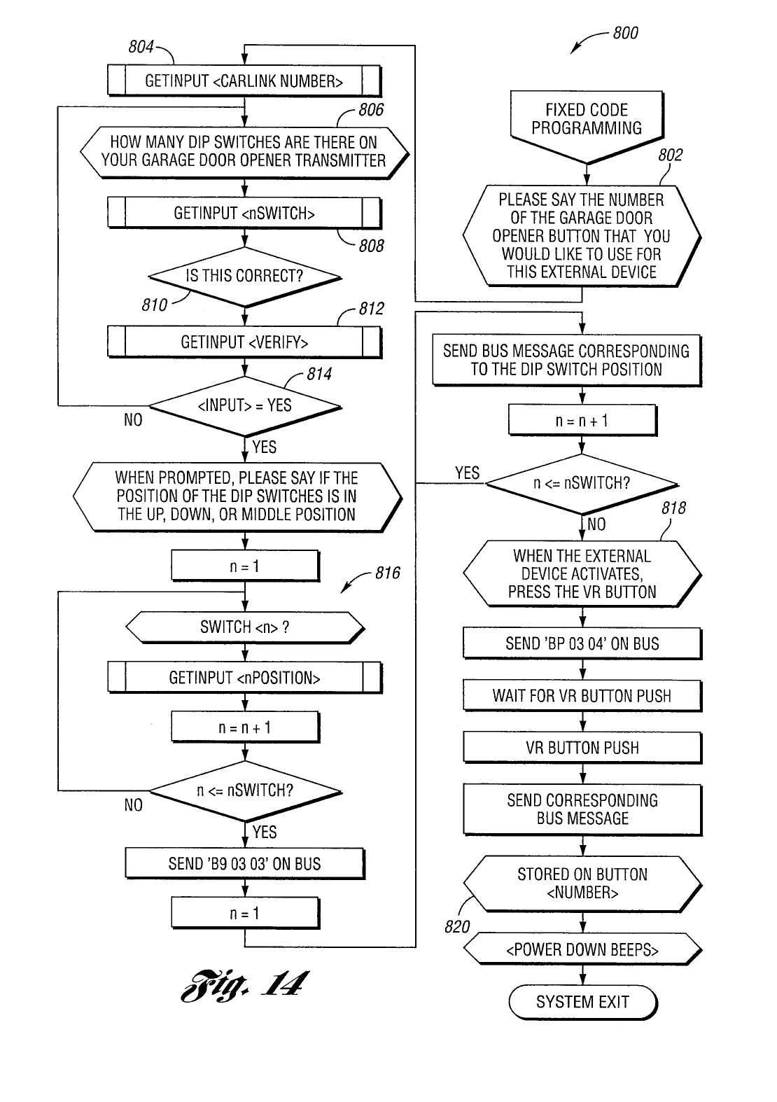

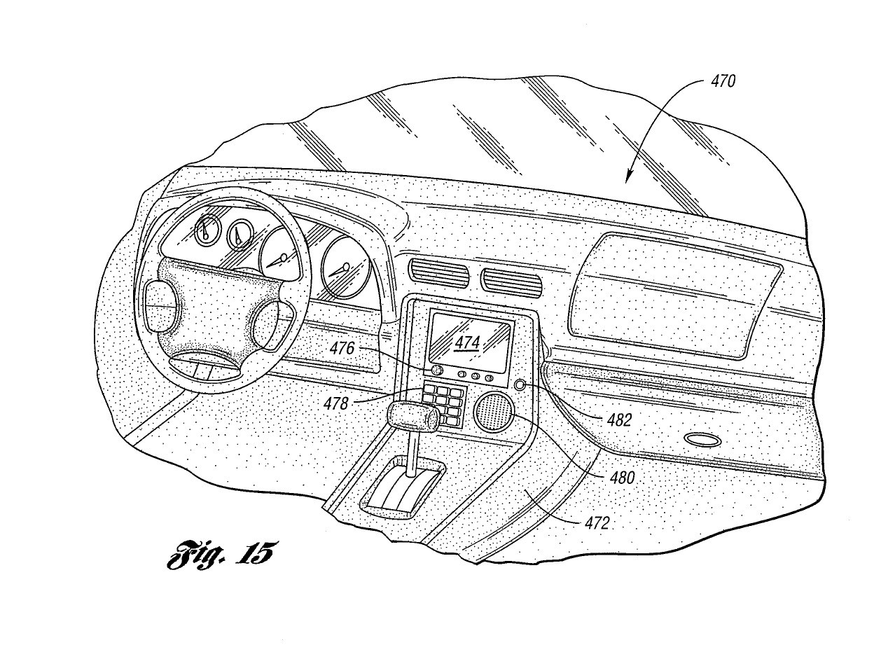

Flowchart 600 in FIG. 12 describes programmable control operation for determining whether the user wants to program or activate programmable controller 30. Flowchart 600 further describes programmable control operation for having the user indicate whether an activation input 164 of programmable control is to be programmed for a fixed code appliance or a rolling code appliance. Flowchart 600 further describes programmable controller operation for programmable control 30 to transmit an appliance activation signal associated with an activation input 164 upon command by the user. Flowchart 700 in FIG. 13 describes programmable control operation for rolling code programming (i.e., training, learning, etc.) of an activation input 164 of programmable control 30 for a rolling code appliance. Flowchart 800 in FIG. 14 describes programmable control operation for fixed code programming (i.e., training, learning, etc.) of an activation input 164 of programmable control 30 for a fixed code appliance.

Programmable controller 30 is put into a mode for listening and responding to user programming and activation information upon the actuation of a voice response (VR) button in communication with the programmable controller. The VR button may be one of activation inputs 164. In this case, the given activation input 164 may have the role of the VR button in addition to serving as a traditional activation input.

Turning to FIG. 12, a user speaks a user voice input 148 indicative of a programmable controller task for receipt by programmable controller 30, as in block 602. Programmable controller tasks recognizable by programmable controller include “Program” and “Activate”. If programmable controller 30 does not hear a programmable controller task while in this setup phase, the programmable controller audibly generates user output 150 advising the user of the available programming and activation options, as in block 604. Programmable controller 30 then waits for receipt of user voice input 148 indicative of the desired programmable controller task. Programmable controller 30 then analyzes user voice input 148 to determine the programmable controller task desired by the user, as in block 606.

If the desired programmable controller task is to “program” programmable controller 30, as in block 608, then programmable controller 30 audibly generates user output 150, as in block 610. This user output 150 is something to the effect “Would you like to program a fixed code device or rolling code device?” Programmable controller 30 then waits for receipt of user voice input 148 indicative of the desired type of programming. Programmable controller 30 then analyzes user voice input 148 to determine the programming type desired by the user, as in block 612. If the desired programming type is to program programmable controller 30 for a rolling code appliance, as in block 614, then programmable controller 30 initiates rolling code programming (shown in FIG. 13). Likewise, if the desired programming type is to program programmable controller for a fixed code appliance, as in block 614, then programmable controller 30 initiates fixed code programming (shown in FIG. 14).

If the desired programmable controller task is to “activate” programmable controller 30, as in block 616, then programmable controller 30 waits for receipt of user voice input 148 indicative of which activation input 164 is to be activated for generation of an appliance signal, as indicated in block 618. User voice input 148 may be something to the effect as “button number 1” or “garage door opener” when it is known by the user and programmable controller 30 that activation input 164 “number 1” corresponds to the GDO.

If programmable controller 30 does not hear an indication as to which activation input 164 is to be activated, then the programmable controller audibly generates user output 150 advising the user to identify the activation input 164 which is to be activated, as in block 620. Programmable controller 30 then waits for receipt of user voice input 148 indicative of the desired activation input 164 to be activated. Programmable controller 30 then analyzes user voice input 148 to determine which activation input 164 is to be activated, as in block 622.

As an example, if the activation input 164 is “button number 1”, as in block 624, then programmable control 30 activates to transmit the RF activation signal corresponding to the activation input. The elements of programmable control may be distributed such that control logic 130 and transmitter section 132 are connected to one another via a bus. As such, in this case, control logic 130 transmits a control signal over the bus for receipt by transmitter section, as in block The control signal is based on the activation input 164 which is to be activated and represents the stored activation signal characteristics which are associated with the activation input 164 to be activated. In turn, transmitter section 132 transmits the RF appliance signal in accordance with the control signal.

Turning to FIG. 13, rolling code programming is initiated. Initially, an element of programmable controller 30 generates a signal on vehicle bus for the various elements of programmable controller to be aware that rolling code program is initiated, as in block 702. Programmable controller 30 then audibly generates user output 150 to request the user audibly identify the activation input 164 that is to be associated with an appliance, as in block 704. Programmable controller 30 then waits for user voice input 148 indicative of the activation input 164, as in block After receipt of such user voice input 148, programmable controller 30 audibly generates user output 150 advising the user to put the appliance in learning mode, as in block 708. In turn, the user puts the appliance in the learning mode and then indicates to programmable controller 30 that this task has been completed. For instance, the user presses the VR button to advise programmable controller 30 that the appliance has been placed in the learning mode, as in block 710. After being advised that the appliance has been placed in the learning mode, as in block 712, programmable controller 30 then implements the guess-and-test rolling code programming by transmitting different rolling code activation signals one at a time as described herein. Prior to implementing this guess-and-test rolling code programming, programmable controller 30 audibly generates a user output 150 advising the user to press the VR button once the appliance has been activated, as in block 714. As described herein, the appliance will be activated upon receiving a proper one of the many different rolling code activation signals from programmable controller 30. Upon receiving user indication that the appliance has been activated, which happens when the appliance receives its proper rolling code activation signal, programmable controller 30 associates the signal characteristics indicative of the proper rolling code activation signal with the activation input 164 which is associated with the appliance. Programmable controller 30 then audibly generates user output 150 indicative of same for the user to hear, as in block 716.

Turning to FIG. 14, fixed code programming is initiated. Initially, programmable controller 30 audibly generates user output 150 requesting the user to identify the activation input 164 to be associated with an appliance, as in block Programmable controller 30 waits for user voice input 148 indicative of same, as in block 804. After receiving such user voice input 148, programmable controller 30 audibly generates user output 150 requesting the user to identify the amount of fixed code DIP switches or the like on the appliance, as in block 806. Programmable controller 30 waits for user voice input 148 indicative of same, as in block 808, and performs a verification process, as in blocks 810, 812, and 814.

Programmable controller 30 then initiates a process for obtaining user voice input 148 indicative of the switch position, as generally identified by 816. As described, the switch positions is indicative of the fixed code to be used for the appliance. Upon learning of the fixed code in this manner, programmable controller transmits an activation signal in accordance with the fixed code. Programmable controller 30 then waits for the user to indicate that the appliance has been activated, as in block 818. After the user confirming same, programmable controller 30 associates the fixed code programming information with the activation input 164 associated with the appliance. Subsequently, programmable controller 30 audibly generates user output 150 indicative of same for the user to hear, as in block 820.

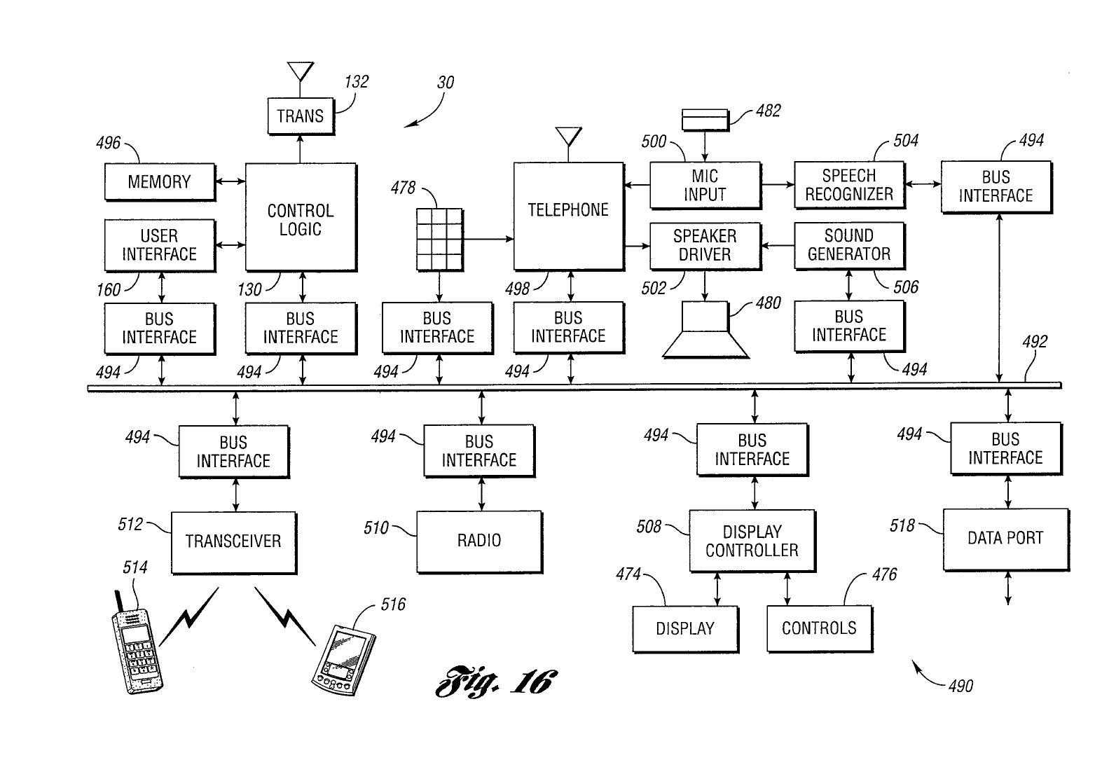

Referring now to FIG. 15, a drawing illustrating a vehicle interior 470 that may be used to program a programmable controller according to an embodiment of the present invention is shown. Vehicle interior 470 includes console 472 having one or more of a variety of user interface components. Graphical display 474 and associated display controls 476 provide an interactive device for HVAC control, radio control, lighting control, vehicle status and information display, map and positioning display, routing and path planning information, etc. Display 204 can provide instructions for programming and using programmable control 30. Display 474 can provide status and control feedback to the user in training and operating modes. Display controls 476 including, if available, touch-screen input provided by display 474 can be used to provide programming input from users to programmable control 30. In addition, display 474 and controls 476 may be used as activation inputs for programmable control 30.

Console 472 includes numeric keypad 478 associated with an in-vehicle telephone. For fixed code training, numeric keypad 478 can be used to enter the fixed code value. Programmable control 30 may also recognize one or a sequence of key depressions on keypad 478 as an activation input.

Console 472 includes speaker 480 and microphone 482 associated with an in-vehicle telephone, voice activated control system, entertainment system, audible warning system, and the like. Microphone 482 enables a user to speak activation and/or programming information for receipt by programmable control 30. Speaker 480 provides audio feedback from programmable controller 30 for the user to hear during programming and/or activation modes. Microphone 482 and speaker 480 are used to provide programming instructions, interactive help, and the like.

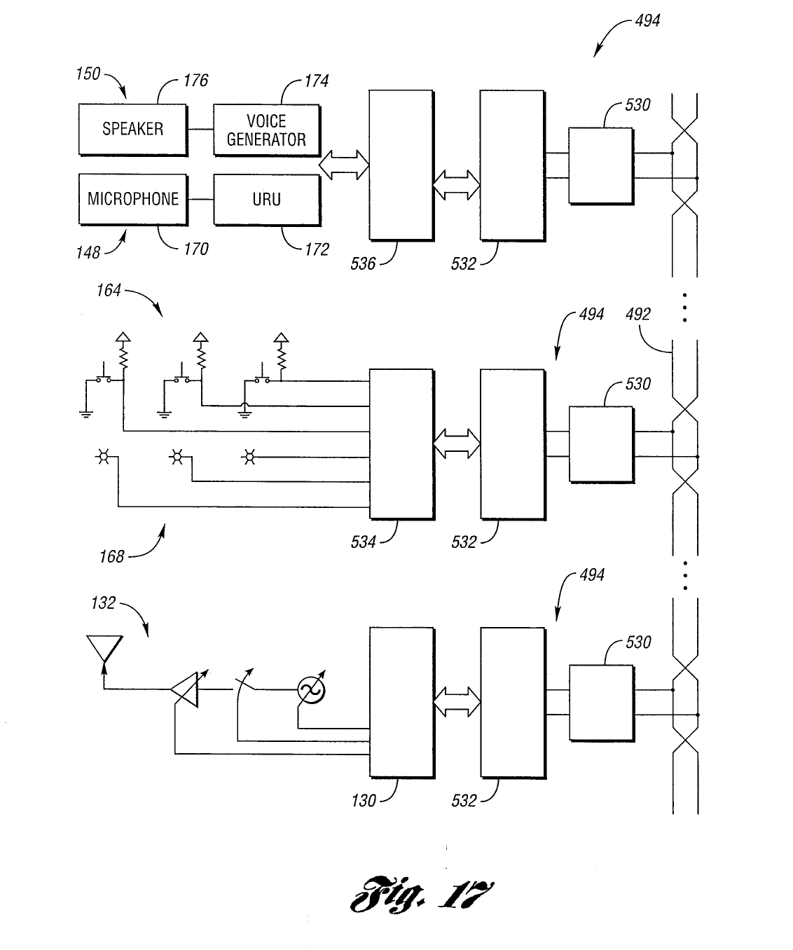

Referring now to FIG. 16, a block diagram illustrating a bus-based automotive vehicle electronic system 490 according to an embodiment of the present invention is shown. Electronic system 490 includes interconnecting bus 492. Automotive communication buses may be used to interconnect a wide variety of components within the vehicle, some of which may function as interface devices for programming or activating appliance controls. Many standards exist for specifying bus operations such as, for example, SAE J-1850, Controller Area Network (CAN), and the like. Various manufacturers provide bus interfaces 224 that handle low level signaling, handshaking, protocol implementation and other bus communication operations.

Electronics system 490 includes programmable control 30. Programmable control 30 includes at least control logic 130 and transmitter (TRANS) 132. Control logic 130 accesses memory 496, which holds a plurality of activation schemes. Each scheme describes activation control signals used by control logic 130 to transmit activation signals by transmitter 132. User interface 160 interfaces control logic 130 with user activation inputs and outputs. User interface 160 may be directly connected to control logic 130 or may be connected through bus 492. This latter option allows control logic 130 and transmitter 132 to be located anywhere within vehicle 32.

Electronics system 490 may include wireless telephone 498 interfaced to bus 492. Telephone 498 can receive input from keypad 478 and from microphone 482 through microphone input 500. Telephone 498 provides audio output 150 from control logic 130 to speaker 480 through speaker driver 502 for the user to hear. Telephone 498 may be used to contact a human or automated help system and may also be used as a data port to download scheme and software updates into memory Keypad 478 may be directly interfaced to bus 492 allowing keypad 478 to provide user input 148 to control logic 130. Microphone 482 provides user voice input 148 through microphone input 500 to speech recognizer 504. Speech recognizer 504 is interfaced to bus 492 allowing microphone 482 to provide user voice input 148 for control logic 130. Sound generator 506 supplies computerized voice signals 150 for audible reproduction to speaker 480 through speaker driver Sound generator 506 may be capable of supplying tone-based signals in addition to artificial speech signals. Sound generator 506 is interfaced to bus 492 thereby allowing control logic 130 to generate audible signals 148 for a user to hear.

Display controller 508 generates signals controlling display 474 and accepts display control input 476. Display controller 508 is interfaced to bus 492 thereby allowing control logic 130 to initiate graphical output on display 474 and receive user input 148 from controls 476.

Radio 510 is interfaced to bus 492 thereby allowing control logic 130 to initiate display through radio 510 and receive input from controls on radio 510. For example, volume and tuning controls on radio 510 may be used to enter a fixed code value. Rotating the volume knob may sequentially cycle through the most significant bits of the code and rotating the tuning knob may sequentially cycle through the least significant bits of the code. Pushing a radio control can then send the fixed code to control logic 130.

Wireless transceiver 512 is interfaced to bus 492 through bus interface 494. Wireless transceiver 512 communicates with wireless communication devices, represented by 514 and 516, such as portable telephones, personal digital assistants, laptop computers, through infrared or short range RF signals. Various standards exist for such communications including IEEE 802.11, Bluetooth, IrDA, and the like. Transceiver 512 is interfaced to bus 492, permitting wireless devices 514, 516 to provide input to and receive output from control logic 130. Wireless devices 514, 516 may also be used as a data port to upload code and scheme data into memory 496 and/or to exchange data with programmable control 30 for assisting in its programming.

Data port 518 implements a data connection interfaced to bus 492 through bus interface 494. Data port 518 provides an interface for exchanging digital information. One or more standards may be supported, such as IEEE 1394, RS-232, SCSI, USB, PCMCIA, and the like. Data port 518 may be used to upload code and scheme data into memory 496 and/or exchange data with programmable control 30 for assisting in its programming.

Referring now to FIG. 17, a block diagram illustrating distributed control elements interconnected by a vehicle bus according to an embodiment of the present invention is shown. Bus 492 is a CAN bus. Bus interface 494 may be implemented with CAN transceiver 530 and CAN controller 532. CAN transceiver 530 may be a PCA82C250 transceiver from Philips Semiconductors. CAN controller 232 may be a SJA 1000 controller from Philips Semiconductors. CAN controller 232 connects directly with data, address, and control pins of certain microcontrollers such as, for example, an 80C51 family microcontroller from Intel Corporation.

In the example shown, control logic 130 and transmitter 132 are supported by a first bus interface 494. Activation inputs 164 provide inputs to, and indicators 168 are driven by, microcontroller 534 which is supported by a second bus interface 494. Microphone 170 and VRU 172 for user voice input 148 are connected to microcontroller 536 which is supported by a third bus interface 494. Likewise, voice generator 174 and speaker 176 for user voice output 150 are connected to microcontroller 536 which is also supported by third bus interface 494. Serial bus 492 and separate interfaces 494 permit various components of programmable control 30 to be placed in different locations within vehicle 32. One advantage of separate location is that transmitter 132 may be placed at a location optimizing RF transmission from vehicle 32. Another advantage of separately locating components of programmable control 30 is to facilitate the design of vehicle interior 470. For example, activation inputs 164 and indicator lamps 168 may be located for easy user access such as in an overhead console, a visor, a headliner, and the like. Another advantage of a bus-based programmable control 30 is the ability to interface control logic 130 with a wide variety of vehicle controls and displays.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A system for wirelessly activating an appliance, the appliance responding to one of a plurality of transmission schemes, the system comprising:
a transmitter operative to transmit a radio frequency activation signal based on any of the plurality of transmission schemes;
at least one user activation input, each activation input identifying a wireless channel;
memory holding data describing a plurality of rolling code transmission schemes and a plurality of fixed code transmission schemes;
a voice recognizer for converting human user speech into electrical signals, and a voice generator for converting electrical signals into human user speech;
control logic in communication with the transmitter, the at least one user activation input, the voice recognizer, the voice generator, and the memory, the control logic implementing a rolling code programming mode, a fixed code programming mode, and an operating mode;
the control logic in rolling code programming mode generating and transmitting a sequence of rolling code activation signals until the voice recognizer receives human speech from a user indicating a successful rolling code transmission scheme, each rolling code activation signal in the sequence of rolling code activation signals based on a different one of the plurality of rolling code transmission schemes, the control logic storing data specifying the successful rolling code transmission scheme associated with one of the at least one activation inputs and causing the voice generator to audibly generate human speech indicative of the activation input associated with the successful rolling code transmission scheme for the user to hear;
the control logic in fixed code programming mode receiving a fixed code from the voice recognizer upon the voice recognizer receiving human speech from a user identifying the fixed code, the control logic then generating and transmitting a sequence of fixed code activation signals until the voice recognizer receives human speech from a user indicating a successful fixed code transmission scheme, each fixed code activation signal in the sequence of fixed code activation signals based on one of the plurality of fixed code transmission schemes and each transmitting the received fixed code, the control logic storing the fixed code and data specifying the successful fixed code transmission scheme associated with one of the at least one activation inputs and causing the voice generator to generate human speech indicative of the activation input associated with the successful fixed code transmission scheme for the user to hear;
the control logic in operating mode receiving identification of an activation input to be activated from the voice recognizer upon the voice recognizer receiving human speech from a user identifying the activation input to be activated, retrieving data associated with the identified activation input, and transmitting an activation signal based on the retrieved data.

2. The system of claim 1 wherein:
the at least one activation input is a plurality of activation inputs.

3. The system of claim 2 wherein:
each activation input comprises a switch and the user programming input comprises the same plurality of switches.

4. The system of claim 1 wherein:
the control logic pauses for user input after transmission of at least one fixed code activation signal in the sequence of fixed code activation signals.

5. The system of claim 1 wherein:
the control logic pauses for user input after transmission of at least one rolling code activation signal in the sequence of rolling code activation signals.

6. The system of claim 1 wherein:
membership in the transmitted sequence of fixed code signals is based on the number of bits in the received fixed code.

7. The system of claim 1 wherein:
the sequence of fixed code signals comprises at least one pair of fixed code activation signals based on the same fixed code transmission scheme, one fixed code activation signal in each pair based on a reversal of the fixed code.

8. The system of claim 1 wherein:
the sequence of fixed code signals comprises at least one pair of fixed code activation signals based on the same fixed code transmission scheme, one fixed code activation signal in each pair based on an inverse of the fixed code.

9. The system of claim 1 wherein:
at least one of the sequence of fixed code signals and the sequence of rolling code signals is ordered based on a popularity of schemes, thereby reducing an average latency time until user input indicates a successful scheme.

10. The system of claim 1 further comprising:
a vehicle bus in communication with the control logic.

11. A method of activating an appliance, the appliance controlled by a radio frequency activation signal, the method comprising:
if a user verbally indicates that the appliance is activated by a rolling code activation signal, transmitting a sequence of different rolling code activation signals until the user verbally indicates a successful rolling code transmission, then storing data representing a rolling code scheme used to generate the successful rolling code transmission;
if the user verbally indicates that the appliance is activated by a fixed code activation signal, using a fixed code word to generate and transmit each of a sequence of different fixed code activation signals until the user verbally indicates a successful fixed code transmission, then storing data representing the fixed code word and a fixed code scheme used to generate the successful fixed code transmission; and
in response to the user verbally identifying an activation input, generating and transmitting an activation signal based on stored data.

12. The method of claim 11 further comprising:
storing data representing either the rolling code scheme used to generate the successful rolling code transmission or the fixed code word and the fixed code scheme used to generate the successful fixed code transmission associated with one of a plurality of activation inputs.

13. The method of claim 11 further comprising:
determining which of a plurality of fixed code transmission schemes will be used in the sequence of different fixed code activation signals based on a number of bits in the fixed code word.

14. The method of claim 15 wherein:
at least one of the sequence of different fixed code activation signals and the sequence of different rolling code activation signals is ordered based on a popularity of schemes.

15. A method of programming a programmable remote control, the remote control programmable to one of a plurality of appliance activation schemes, the method comprising:
receiving user type voice input specifying activation signal type;
if the user type voice input specifies variable code type, transmitting variable code activation signals until receiving user success voice input indicating a target appliance has been activated;
if the user type voice input specifies fixed code type, receiving user fixed code voice input providing a fixed code and transmitting fixed code activation signals until receiving user success voice input indicating the target appliance has been activated; and
storing information specifying an activation signal for activating the target appliance based on the received user success voice input.

16. The method of claim 15 further comprising:
receiving data specifying characteristics of at least one of the plurality of appliance activation schemes over a vehicle bus.

17. The method of claim 15 further comprising:
receiving data specifying characteristics of at least one of the plurality of appliance activation schemes over a serial bus.
